(19) United States
(12) Patent Application Publication
(10) Pub. No.: US 2006/0208384 A1
(43) Pub. Date: Sep. 21, 2006

(54) Method for producing an electroconductive composite material

(75) Inventors: Raman Aram Mnatsakanyan, Yerevan (AM); Gagik Gurgen Karamyan, Yerevan (AM); Khadjak Hrachik Gyulumyan, Yerevan (AM); Hakob Hovhannes Sargsyan, Yerevan (AM); Varuzhan Vahag Melikyan, Yerevan (AM)

Correspondence Address: Harold A. Gell, Jr., 13720 Lockdale Road, Silver Spring, MD, 20906-2117, US

(73) Assignee: "H2ECOnomy" CJSC

(21) Appl. No.: 11/352,218

(22) Filed: Feb. 13, 2006

(30) Foreign Application Priority Data
Mar. 17, 2005 (AM) P20050024

(51) Int. Cl. C04B 35/00

(52) U.S. Cl. 264/105; 264/122

(57) ABSTRACT

The invention is a method for the manufacturing of electroconductive composite materials based on carbon-polymer mixtures meant for use as coatings, electrodes and current collectors in electrical and electrochemical units, particularly in fuel cells. According to the invention, a mixture is formed in two successive steps. During the first step the polymer binder, at a temperature close to its melting point, is mixed in an extruder with the maximum amount of said carbon filler to provide a viscous mixture allowing extrusion as carbon-polymer sticks. In the second step, additional carbon filler is blended with the sticks to provide a necessary electrical and thermal conductivity of the composite material. The sticks and added carbon are mixed in a grinder, which simultaneously, subjects the blend to mechanochemical activation to provide high mechanical strength and high electrical and thermal conductivity. The process provides low production cost for articles obtained from the composite material.

### BACKGROUND OF THE INVENTION

1. Field of the Invention

The invention relates to a method for manufacturing electroconductive composite materials based on carbon-polymer mixtures meant for fabrication of coatings, electrodes, and current collectors used in electrical and electrochemical units, particularly in fuel cells

### DISCUSSION OF THE RELATED ART

A main component in hydrogen-oxygen/air fuel cells is the collector plate, which provides electrical current transport in the stack. These current collectors (monopolar or bipolar) are manufactured usually from metal, graphite or carbon-polymer composites. Among various properties, collector plates must have high electroconductivity to decrease ohmic losses in electrochemical generators, and at the same time they must be mechanically strong and flexible to withstand mechanical loading during fuel cell stack assembly and operation under real conditions.

Fuel cells also contain cooling plates that are fabricated from carbon-polymer mixtures. In addition to high electroconductivity and strength, the cooling plates must have good thermal conductivity. These plates are usually manufactured by mixing carbon filler with polymer binder and forming the plates by hot molding, injection molding, calendaring or other methods.

The increase of electroconductive filler in the process of manufacturing carbon-polymer composite materials results in increased electroconductivity of an article, however, at the same time the mechanical strength of the article is decreased, and vice versa, the decrease of the content of electroconductive filler (for example carbon) leads to a reduction of the plate's electrical and thermal conductivity but results in higher mechanical strength.

A known method for manufacturing electroconductive composite material based on a carbon-polymer mixture is presented in US Patent Application No. 2004/0028993; Int. Cl.⁷ H01M4/96; H01M4/88, H01 B 1/24, published on Feb. 12, 2004. According to the patent, the polymer binder in the form of powder or pellets is dispersed uniformly in the flake graphite powder by a mixer, producing the mix which is extruded at a temperature greater than the melting point of polymer binder to form a paste that is transferred into a mold at a temperature lower than the melting temperature of the polymer binder and subjected to the compression. According to that method, the mix comprises from 40 to 90% by volume of a flake graphite powder obtained by calendaring and/or rolling, and, as additives, up to 25% by volume of conductive fibers with a length of between 0.5 and 10 mm (carbon fibers, stainless steel fibers, nickel coated carbon fibers). As a result, the composite material gains a rather high electroconductivity (in the case of bipolar plate the transverse conductivity, namely the conductivity measured in the direction perpendicular to the main faces of the plate, varies between 1 and 30 S/cm), as well as high thermal conductivity in the direction parallel to the surface of bipolar plate, which helps to dissipate heat towards the outside of the fuel cell stack and optimize cooling thereof. However, this method does not provide the necessary mechanical strength of the composite material and articles made from this material, due to the weak bonds between filler particles.

It is also known the method of production of electroconductive composite material on the base of carbon-polymer mixture (see U.S. Pat. No. 4,882,102, Int. Cl.⁷ B05D031/02; C01B/, published on Nov. 21, 1989—closest analogue) substantially strengthens the bonds between filler particles and thus increases the mechanical strength of articles formed from such composite material. According to this method, the mixture is formed through uniformly dispersing the polymer binder in a fine carbon powder by means of a mixer, then the mixture is subjected to mechanochemical activation and a composite material is formed.

High-energy grinders are usually used to accomplish the mechanochemical activation. For example, this known method is realized in mills of planetary, jet, knife types or disintegrators, or by mixing rolls or rotary ball mills. In such mills, in addition to effective blending of the mixture components, the tribomechanical attrition grinding of carbonaceous filler and binder particles also occurs. Owing to mechanochemical activation, the reduction of particles size of up to 10 microns and lower takes place, i.e. a growth of their specific surface, as well as the polymer binder is physicochemically more strongly bonded with the particles of carbon fine powder because applied high stresses result in distortion and disturbance of the crystal lattice, amorphousation, formation of lattice defects or active centers at particle surfaces, localized high temperature and pressure conditions and/or formation of rest sections having fields of high potential. Depending on the type and design of grinder or mill, a mechanochemical activation takes place when the linear speed of the plant rotor exceeds defined threshold values at which the sharp growth of mechanical strength of articles produced by such methods is observed. This known method allows increasing the bending strength of the obtained plates up to 45 kg/cm2. However, such high mechanical value is obtained at 10% by mass of carbon powder which can not provide the necessary transverse electroconductivity (25-50 S/cm) and thermal conductivity (10-15 W/m·K) of plates fabricated from such composite material but such values can be achieved at the content of carbon powders of 70-90% by mass. Meanwhile, it is obvious from the cited patent description that the addition of each 5% by mass of carbon powder leads to the decrease of bending strength by 5 kg/mm2. From the other side, according to the said method, the mix is subjected to a mechanochemical activation in the form of viscous paste, and the content of carbon powder in the mix can not exceed 70% by mass because it is not possible to perform mechanochemical activation and obtain a necessary mechanical strength of the composite material due to insufficient viscosity of the mix. Thus, this method also does not allow simultaneous acquisition of high mechanical strength, as well as high electrical and thermal conductivity. The known methods are also characterized by the utilization, in general, of expensive fine polymer powders, which appreciably increase the manufacturing cost of the composite material.

### OBJECTIVES OF THE INVENTION

The objective of this invention is to increase the mechanical strength, electrical and thermal conductivity, as well as to reduce the production cost of the articles obtained from composite materials made by the proposed method with a reduced amount of polymer binder, through intensifying (i.e. increasing the specific activation) the mechanochemical activation of carbon-polymer mixture.

### SUMMARY OF THE INVENTION

The essence of the invention, lies in the method for producing an electroconductive composite material including formation of a mixture by blending a polymer binder with a carbon filler, subjecting it to mechanochemical activation in a high energy grinder and then molding it, wherein, according to the invention, said formation of the mixture is performed in two successive steps, where in the first step the polymer binder, at a temperature close to the melting point, is blended in an extruder with the maximum amount of said carbon filler to provide a viscous mixture which allows extruding carbon-polymer sticks. In the second step, the additional carbon filler required to provide a necessary electrical and thermal conductivity of the composite material is added to said sticks and the obtained mass is mixed in the grinder while simultaneously subjecting it to mechanochemical activation.

### DESCRIPTION OF THE PREFERRED EMBODIMENT

The proposed new, unique and useful means for producing an electroconductive composite material is realized according to the following inventive method:

The polymer binder (for example, inexpensive granulated thermoplastic polymers such as polyethylene, polypropylene, polyethylene terephtalate, etc.) at a temperature close to its melting point is mixed in an extruder (for example, in a screw extruder) with carbonaceous filler of a maximal amount necessary for forming the viscous mix allowing extrusion, whereby carbon-polymer sticks having the length of at least 5 mm and diameter of 5 mm are obtained. The minimal size of the sticks is conditioned by the technological possibilities of known present-day extruders.

The necessary viscosity of the mixture to allow its formation by the extruder is usually provided by the temperature of thermoplastic polymer that is kept close to its melting temperature and when the quantity of filler does not exceed the amount of binder, then additional carbonaceous material is added to the obtained carbon-polymer sticks so that the total content of the carbon filler will achieve 70-90%, at which the composite material gains the required high electrical and thermal conductivity. Further, the obtained mass is loaded into a high energy mill (for example, planetary mill, jet mill, cutter impact mill, grinder, etc. which ensures the linear speed of milling components of 7-25 m/s), and blended while simultaneously subjecting it to the mechanochemjcal activation. The obtained powdered mixture subjected to mechanochemical activation is extracted from the mill and molded by hot pressing, compression, injection molding, calendaring or any known.

The first step of the inventive method is preparing the mix comprised of brittle carbon-polymer sticks having a length of at least 5 mm and a diameter of 5 mm. The particles, sticks, produced are weak and brittle but consist of bonded together carbon filler and the polymer binder. Next, additional amounts of carbonaceous filler are combined with the carbon-polymer brittle sticks in a high energy mill which substantially promotes the intensifying of the mechanochemical activation, i.e. increases the specific activation (as the process of milling become effective, in each unit of the mass the amount of micro defects, micro cracks, active centers, etc. is increased), and the binder particles are bonded physico-chemically more strongly with the filler particles in comparison with a one step activation process of paste or powder mixtures.

Usually a high electroconductivity (25-50 S/cm) and high thermal conductivity (10-15 W/m·K) is achieved by adding of 70-90% of total carbonaceous filler in the composite material.

The formation of the mix in this two step process allows, first, in contrast to the closest analogues, the use of a four times less expensive granulated binder (5-10 mm in diameter) because obtaining the sticks by extrusion does not require a fine powdered binder. In addition, in the case of a one step process of mixture preparation, it is not possible to obtain the necessary mechanical strength, thermal and electrical conductivity of the articles produced. The grinding process in high energy mills becomes difficult to perform because particles or granules of polymer binder are heated and adhere the grinding parts of the mill. To prevent this phenomenon, the binder particles are usually cooled, for example, by liquid nitrogen, before being loaded into the mill, or the mill itself is cooled which complicates and raises the price of the process of plate fabrication. In other words, the set of mentioned important characteristics of the proposed method allows a considerable decrease in the cost of articles obtained from composite material by this method.

The following examples illustrate and elucidate the present invention:

### EXAMPLE 1

400 g of natural graphite powder and 400 g of polypropylene granules are mixed in a screw extruder at a temperature close to the melting point of binder (about 180-190° C.) and carbon-polymer sticks with a length of 10 mm and a diameter of 5 mm are obtained by extrusion. Then, 600 g of natural graphite powder is combined with the sticks, reducing by this the amount of binder in the composite material up to 28.6% by mass. The obtained mass is inserted into a high-energy grinder and subjected to milling for 30 minutes at a rotor speed of 8000 revolutions per minute. The obtained mechanically activated powdered mixture is removed from the grinder and filled into a mold which is heated to a temperature close to the melting point of polypropylene (180-190° C.), and the mass is hot pressed for 5 minutes at a constant pressure of 240-260 kg/cm2. After cooling the mold to room temperature and decompressing, the plate-like article is removed from the mold. The resultant plate has the characteristics shown in Table 1:

TABLE 1

| Graphite | Speed of | | | |
|---|---|---|---|---|
| content | grinder | Flexural | Specific | Thermal |
| in the | rotor, | strength, | electroconductivity, | conductivity, |
| mixture, % | rev/min | Kg/cm² | S/cm | W/m · K |
| 71 | 8000 | 500 | 50 | 15 |

After decreasing the binder amount of composite material by up to 28.6% by mass in the preceding proposed method, the articles produced possess high mechanical strength electrical and thermal conductivity.

### EXAMPLE 2

The composite material is prepared by the technology in accordance to the previous example except for the speed of the grinder rotor. In this example, the threshold speed of the grinder rotor for achieving mechanochemical activation is 5000 rev/mm but the experiment is carried out at a speed of 3000 rev/mm. The plate obtained in this case exhibits the characteristics presented in Table 2.

TABLE 2

| Graphite | Speed of | | | |
|---|---|---|---|---|
| content | grinder | Flexural | Specific | Thermal |
| in the | rotor, | strength, | electroconductivity, | conductivity, |
| mixture, % | rev/min | Kg/cm² | S/cm | W/m · K |
| 71 | 3000 | 100 | 25 | 10 |

As seen in the preceding example, at a grinder's rotor speed below threshold speed, a mechanochemical activation does not occur, and articles produced by this method exhibit relatively high electrical and thermal conductivity but considerably lower mechanical strength.

### EXAMPLE 3

The composite material is prepared with the total quantities of graphite and polypropylene as in previous examples, however the mixture is formed in a one step process. In this one step process, 1400 g of graphite and 400 g of polypropylene powder (particle size up to 15 microns) were loaded into the grinder and subjected to mixing and mechanochemical activation. The obtained article has the characteristics shown in Table 3.

TABLE 3

| Graphite | Speed of | | | |
|---|---|---|---|---|
| content | grinder | Flexural | Specific | Thermal |
| in the | rotor, | strength, | electroconductivity, | conductivity, |
| mixture, % | rev/min | Kg/cm² | S/cm | W/m · K |
| 71 | 8000 | 200 | 33 | 5 |

As is evident in the third example, in the case of a one step process of carbon-polymer mixture formation the intensification of mechanochemical activation does not occurs and articles produced by this way have considerably low mechanical strength and electrical and thermal conductivity in comparison with the two-step formations.

Thus, experimental data provides evidence that the set of mentioned important characteristics of the proposed invention are in cause-effect relation with the mentioned technical result (intensifying of the mechanochemical activation of carbon-polymer mixture) and make possible reducing the amount of polymer binder in composite material to increase the mechanical strength and electrical and thermal conductivity as well as reducing the production cost of such articles.

While preferred embodiments of this invention have been illustrated and described, variations and modifications may be apparent to those skilled in the art. Therefore, we do not wish to be limited thereto and ask that the scope and breadth of this invention be determined from the claims which follow rather than the above description

What is claimed is:

1. A method for producing an electroconductive composite material, including the steps of:
blending in an extruder a quantity of polymer binder with the maximum amount of a carbon filler that can be added to said polymer binder and still provide a viscous mixture to permit extrusion at a temperature close to the melting point of said polymer binder;
extruding said blended polymer binder and carbon filler from said extruder as carbon-polymer brittle sticks;
combining said carbon-polymer brittle sticks with additional carbon filler to provide a necessary electrical and thermal conductivity of the composite material;
mixing said carbon-polymer brittle sticks and additional carbon filler in a means to produce a mechanochemically activated mixture of said carbon-polymer brittle sticks and additional carbon filler; and
molding said ground, mechanochemically activated mixture in a mold heated to a temperature close to the melting point of said polymer binder and dimensioned to create a desired product.

2. A method as defined by claim 1, wherein said polymer binder is a granulated thermoplastic polymer.

3. A method as defined by claim 1, wherein said polymer binder is selected from the group consisting of polyethylene, polypropylene, polyethylene terephtalate.

4. A method as defined by claim 1, wherein said carbon filler is selected from the group consisting of natural or artificial graphite, expanded, exfoliated, flake graphite, carbon black, carbon fibers, coke, and their mixtures.

5. A method as defined by claim 1, wherein said combining of said carbon-polymer brittle sticks with additional carbon filler is performed to create a mixture containing 70 to 90% carbon.

6. A method as defined by claim 1, wherein said means to produce a mechanochemically activated mixture of said carbon-polymer brittle sticks and additional carbon filler is a high energy grinder.

7. A method as defined by claim 1, wherein said means to produce a mechanochemically activated mixture of said carbon-polymer brittle sticks and additional carbon filler is a high energy grinder, selected from the group consisting of planetary, jet and knife mills, disintegrators, mixing rolls and rotary ball mills.

8. A method as defined by claim 1, wherein said desired product is a hydrogen-oxygen/air fuel cell collector plate.

9. A method as defined by claim 1, wherein said product is selected from the group of coatings, electrodes and current collectors in electrical and electrochemical units.
